(19) United States
(12) Patent Application Publication
(10) Pub. No.: US 2013/0303352 A1
(43) Pub. Date: Nov. 14, 2013

(54) METHOD FOR A MANUFACTURE OF A BAG MADE OF COMPOSITE MATERIAL

(71) Applicant: SACART S.P.A., Senigallia (AN) (IT)

(72) Inventors: Giovanni FIORINI, SENIGALLIA (AN) (IT); Lorenzo PIERGIOVANNI, CESANO DI SENIGALLIA (AN) (IT)

(21) Appl. No.: 13/942,595

(22) Filed: Jul. 15, 2013

Related U.S. Application Data
(62) Division of application No. 13/150,816, filed on Jun. 1, 2011, now abandoned.

(30) Foreign Application Priority Data
Nov. 2, 2010 (IT) AN2010A000188

(51) Int. Cl. B31B 1/74

(52) U.S. Cl. CPC B31B 1/74
USPC 493/186

(57) ABSTRACT

Bag made of a composite material, comprising at least one layer of cellulosic material such as paper or the like, onto which at least one layer of water-soluble polymer material is directly applied and adhered, and method for the manufacture of such bag.

### CROSS REFERENCE TO RELATED APPLICATIONS

The present application claims priority to Italian application AN2010A000188 filed on Nov. 2, 2010, which is incorporated herein by reference in its entirety.

### FIELD

The present disclosure relates to bags made of composite material for the packing and storage of particulate and/or powdery materials, and in particular relates to bags generally used to contain products in the form of powder or granules like concrete, pre-mixed materials for building, minerals, chemicals, seeds and animal feed.

### BACKGROUND

Currently, bags designed for the above-mentioned purposes are generally made using one or more layers of paper and one or more layers of protective material, particularly that capable of forming a barrier against humidity. Normally, the protective material comprises a plastics material, such as PE, PET, PVC or the like, which is connected to the layer of paper in various ways. In this case, the problem lies in the fact that the composite material thus made must be disposed of taking into account the various disposal requirements. In the specific case of products used for building, such as concrete, pre-mixed materials and the like, it would be highly advantageous to be able to introduce a material capable of providing adequate protection against humidity while at the same time being water-soluble, so that it can be introduced directly into the mixer, concrete mixer or the like, into which the product contained in the bag is fed. Once the bag is completely dissolved in aqueous solution, the solid residue of the bag will be composed of cellulose fibres varying in length from a few microns to 4-5 mm, therefore creating no problems from the environmental impact point of view.

For this purpose, the use of polyvinyl alcohol (hereinafter referred as PVA) has been considered. This polymer is universally used due to its excellent resistance to fats, oils and solvents and its ability to act as a barrier to gases.

A bag produced by connecting at least one layer of paper to one layer of PVA film has excellent characteristics from the point of view of resistance to external agents, but its mechanical properties, substantially different from those of the paper to which it is connected, make the production of bags formed simply by superimposing paper and PVA film somewhat problematic;

in fact, such bags present flatness problems as a result of these different mechanical properties.

### SUMMARY

One of the purposes of the present disclosure is therefore to provide a bag made of composite material that is capable of providing the product to be contained in said bag with sufficient protection from external agents, such as gas and humidity, which is completely water-soluble so as to ensure that its disposal will have a low environmental impact, and which can at the same time be produced simply and with a good shape. Another purpose of the disclosure is a method for manufacturing a bag that meets to the above-described requirements.

According to an aspect of the present disclosure, a bag made of composite material is provided, comprising at least one layer of cellulosic material, such as paper or the like, onto which is directly applied, and adhered, at least one layer of water-soluble polymer material, in particular polyvinyl alcohol.

The thickness of the layer of water-soluble polymer material can be in the order of 0.5 to 100 μm, and in particular 10 to 50 μm. According to an embodiment, said bag comprises up to five layers of cellulosic material, of which at least one is connected to a layer of water-soluble polymer material adhered to it.

Said layer of polymer material can be produced by directly depositing an aqueous solution of the water-soluble polymer material. The concentration of the polymer in aqueous solution can vary between 4% and 40% by weight. The aqueous solution can contain additives such as low- molecular-weight polyalcohols, polyethylene glycols and polypropylene glycols or other organic additives capable of changing the viscosity, preventing the formation of bubbles or changing the mechanical properties of the finished product.

According to a further aspect of the present disclosure, a method for manufacturing a bag made of composite material is provided, involving a stage of depositing one or more layers of a solution of water-soluble polymer material in aqueous solution onto a layer of cellulosic material, such as paper or the like, cutting the element thus obtained into single elements, arranging each single element into a tube shape thus forming a plurality of bags, and sealing the bottom of each bag. Should the bag be fitted with a valve, both ends of the bag can be sealed.

According to an embodiment of the disclosure, the depositing stage is performed by a flexographic printing machine provided with a plurality of stations for depositing the water-soluble polymer material.

### BRIEF DESCRIPTION OF THE DRAWINGS

FIG. 1 shows a cross sectional view of a bag in accordance with the disclosure.

FIG. 2 shows a flow chart indicating a method to manufacture a bag in accordance with the disclosure.

### DETAILED DESCRIPTION

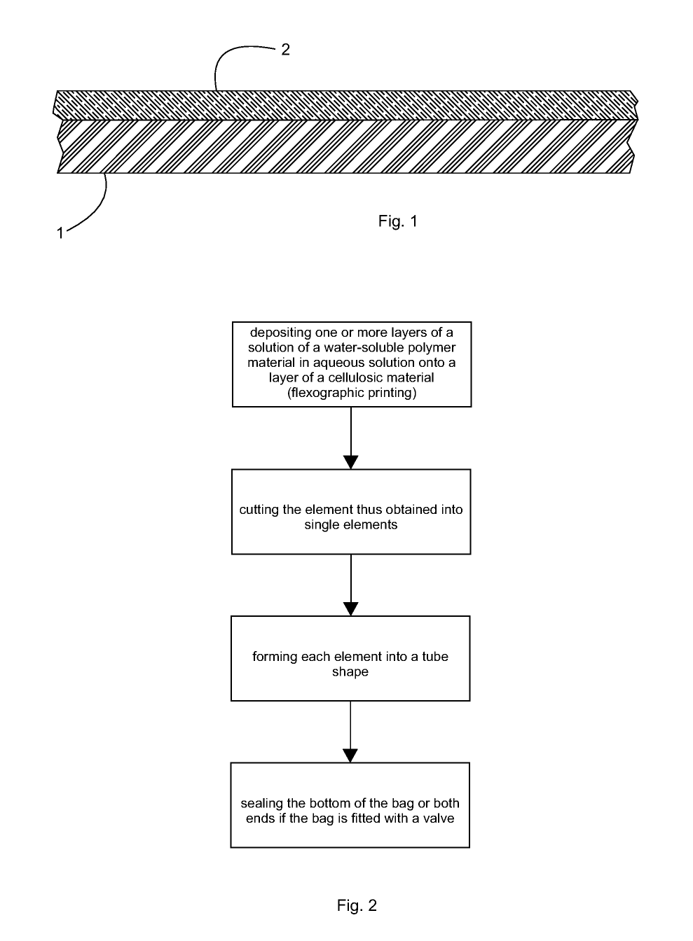

According to an embodiment of the disclosure, the bag is made using one or more layers of virgin fibre paper (white or Havana) with a degree of repulpability tested and determined in accordance with the UNI EN ISO 5263-1 standard (Wet Disintegration of Paper Pulp). The tube, from which the bag is later formed, can be made by joining together up to five layers of paper, for example by depositing on at least one of said layers (see, e.g., layer 1 of FIG. 1) a layer of water-soluble polymer material (see, e.g., layer 2 of FIG. 1), and in particular polyvinyl alcohol. Indeed, as previously mentioned above, this polymer acts as an excellent barrier to gases and solvents. It is completely water-soluble, and for example used in a formulation with a degree of hydrolysis of between 70 and 99%, typically 88%, with molecular weights of between 10,000 and 300,000 g/mol.

The polymer concentration in aqueous solution can vary between 4% and 40% by weight. The aqueous solution can contain additives such as low-molecular-weight polyalcohols and polyethylene glycols and polypropylene glycols or other organic additives capable of changing the viscosity, preventing the formation of bubbles or allowing to change the mechanical properties of the finished product.

According to an embodiment of the method of the present disclosure, the aqueous solution is applied onto the surface of the paper using a flexographic printing machine, of a known type, which normally comprises a system comprising two or more rollers for depositing the polymer material, arranged in series, in a device that includes a transit station in a temperature-controlled environment after each polymer material mixture depositing station. This configuration allows a plurality of layers of polymer material to be deposited substantially contemporaneously, with savings in production times. Moreover, this type of solution allows the thicknesses of PVA spread over the layer of paper to be very precisely controlled, given that the operation can be repeated several times and the amount of polymer material to be deposited can be appropriately set. The PVA should be in aqueous solution with a concentration of between 4% and 40% by weight; varying the concentration should of course affect the amount of PVA deposited at each depositing pass. Generally, the thickness of the PVA layer should be no less than 0.5 μm and no more than 100 μm; in fact, thicknesses of less than 0.5 μm would not guarantee the required effectiveness of the protection, and thicknesses of more than 100 μm could present problems as regards the mechanical properties of the resulting composite.

Once the desired thickness of polyvinyl alcohol is obtained on the layer or layers of paper, the composite thus obtained can first be prepared in a tubular configuration and then one or both ends can be sealed if a bag with a valve fitted at the bottom is to be made. Any printing on the paper should of course be done using water-soluble inks and the adhesives used to form the tube and seal the ends of the bag must also be water-soluble.

Therefore, according to several embodiments of the disclosure, the bag is made in a very simple and convenient way and provides excellent performance as regards the protection afforded to the material contained in the bag. Moreover, according to several embodiments of the disclosure, the bag is completely water-soluble and can therefore be easily disposed of.

A number of embodiments of the disclosure have been described. Nevertheless, it will be understood that various modifications may be made without departing from the spirit and scope of the present disclosure. Accordingly, other embodiments are within the scope of the following claims.

1-19. (canceled)

20. A method for manufacturing a bag made of composite material, comprising the steps of:
depositing one or more layers of a solution of a water soluble polymer material in aqueous solution onto at last one layer of a cellulosic material,
cutting an element obtained from the depositing step into single elements,
arranging each single element into a tube shape thereby forming a plurality of bags, and
sealing a bottom of each bag of the plurality of bags or both ends of each bag of the plurality of bags if the bags are fitted with valve means,
wherein the water soluble polymer material is polyvinyl alcohol and a concentration of polyvinyl alcohol in aqueous solution is comprised between 4% and 40% by weight.

21. The method according to claim 20, wherein a thickness of the one or more layers of water soluble polymer material is from 0.5 μm to 100 μm.

22. The method according to claim 20, wherein each bag of the plurality of bags comprises up to five layers of cellulosic material, of which at least one layer of cellulosic material is connected to a layer of water soluble polymer material directly adhered to the at least one layer.

23. The method according to claim 20, wherein the aqueous solution contains additives comprising low-molecular weight polyalcohols, polyethileneglycols, polypropyleneglycols or other organic additives capable of changing a viscosity, preventing a formation of bubbles or changing mechanical properties of a finished product.

24. The method according to claim 23, wherein the polyvinyl alcohol is used in a formulation with a degree of hydrolysis of between 70% and 99%, with molecular weights between 10,000 g/mol and 300,000 g/mol.

25. The method according to claim 20, wherein the step of depositing is performed by a flexographic printing machine provided with a plurality of stations for depositing the water-soluble polymer material.

26. The method according to claim 20, wherein the cellulosic material is paper.

27. The method according to claim 21, wherein the thickness is from 10 μm to 50 μm.
